(19) United States
(12) Patent Application Publication
(10) Pub. No.: US 2015/0048022 A1
(43) Pub. Date: Feb. 19, 2015

(54) O-RING FILTER SEAL, ASSEMBLY AND METHOD

(71) Applicant: Honda Motor Co., Ltd., Tokyo (JP)

(72) Inventor: Marcus Odell, Plain City, OH (US)

(73) Assignee: Honda Motor Co., Ltd., Tokyo (JP)

(21) Appl. No.: 13/966,356

(22) Filed: Aug. 14, 2013

(51) Int. Cl. B01D 29/05; B29D 28/00; B29D 99/00

(52) U.S. Cl. CPC B01D 29/05; B29D 99/0053; B29D 28/00; B29K 2021/00
USPC 210/499; 29/428

(57) ABSTRACT

An O-ring filter seal includes an annular sealing portion having a first thickness, a circular mesh filter, and an inner portion formed integrally with the annular sealing portion and disposed radially inwardly relative to the annular sealing portion. The inner portion is molded onto a peripheral edge of the circular mesh filter and has a second thickness that is less than the first thickness.

### BACKGROUND

The present disclosure generally relates to O-ring seals, and particularly relates to O-ring seals having an overmolded filter mesh.

Mesh filters (e.g., wire mesh filters) are sometimes molded into rubber O-rings to create a leak proof filter. These types of filters can be interposed between two bodies that communicate oil or other fluids between one another but require filtration of the communicated oil or fluid. With reference to FIGS. 1-3, an example of such an O-ring filter seal is illustrated and generally designated by reference numeral 10. As shown, the filter seal 10 includes an annular sealing portion 12 overmolded onto a peripheral edge 14a of a circular mesh wire filter 14. The filter seal 10 can be interposed between two bodies 16, 18. The bodies 16, 18 can include respective fluid passages 20, 22 for communicating oil or some other fluid therebetween. The seal 10 can be installed between the bodies 16, 18 for preventing leakage from the passages 20, 22 outside the bodies 16, 18 and forcing fluid passing from one of the bodies to the other of the bodies through the mesh filter 14.

One problem with such O-ring filter seals is that the sealing portion 12 receives a stress load as shown by arrows 24 from the bodies 16, 18 and simultaneously is overmolded and required to hold the mesh filter 14. This can sometimes result in cracks developing, such as illustrated crack 26. Specifically, crack 26 can originate within the sealing portion 12 at approximately the location where the sealing portion 12 contacts and overmolds the wire mesh 14. Such a crack 26 can create a leak path allowing fluid in the passages 20, 22 to escape between the bodies 16, 18.

### SUMMARY

According to one aspect, an O-ring filter seal includes an annular sealing portion having a first thickness, a circular mesh filter, and an inner portion formed integrally with the annular sealing portion and disposed radially inwardly relative to the annular sealing portion. The inner portion is molded onto a peripheral edge of the circular mesh filter and has a second thickness that is less than the first thickness.

According to another aspect, a filter assembly includes a first bearing surface, a second bearing surface spaced apart and opposite from the first bearing surface, and an O-ring seal interposed between the first and second bearing surfaces. The O-ring seal has an annular sealing portion in contact with the first and second bearing surfaces and an inner portion formed integrally with the annular sealing portion and disposed radially inwardly relative to the annular sealing portion. The inner portion is overmolded onto a mesh filter and arranged so as to be spaced apart from at least one of the first and second bearing surfaces to reduce a stress load from the first and second bearing surfaces to the inner portion of the O-ring seal that holds the mesh filter.

According to a further aspect, a method for assembling an O-ring filter assembly includes overmolding an inner portion of an O-ring filter seal onto a mesh filter and installing the O-ring filter seal between a first body and second body. The inner portion of the O-ring filter seal is integrally formed with an annular sealing portion disposed radially outside the inner portion. The annular sealing portion has a first thickness and the inner portion has a second thickness. The second thickness is less than the first thickness. The first body has a first bearing surface and the second body has a second bearing surface. The first and second bearing surfaces are engaged with the sealing portion and apply a stress load thereto that is spaced apart from the inner portion overmolded on the filter mesh.

### BRIEF DESCRIPTION OF THE DRAWINGS

FIG. 1 is a perspective view of a known O-ring filter seal.

FIG. 2 is a cross-sectional view of the O-ring filter seal taken along the line 2-2 of FIG. 1.

FIG. 3 is a schematic cross-sectional view showing the O-ring filter seal installed and interposed between two bodies for fluidly sealing the bodies and filtering fluid passing between the bodies.

FIG. 4 is a perspective view of an O-ring filter seal according to an exemplary embodiment.

FIG. 5 is a cross-sectional view of the O-ring filter seal taken along the line 5-5 of FIG. 4.

FIG. 6 is a schematic cross-sectional view showing the O-ring filter seal of FIG. 4 installed and interposed between two bodies for fluidly sealing the bodies and filtering fluid passing between the bodies.

FIG. 7 is a block diagram illustrated a method for assembling an O-ring filter assembly.

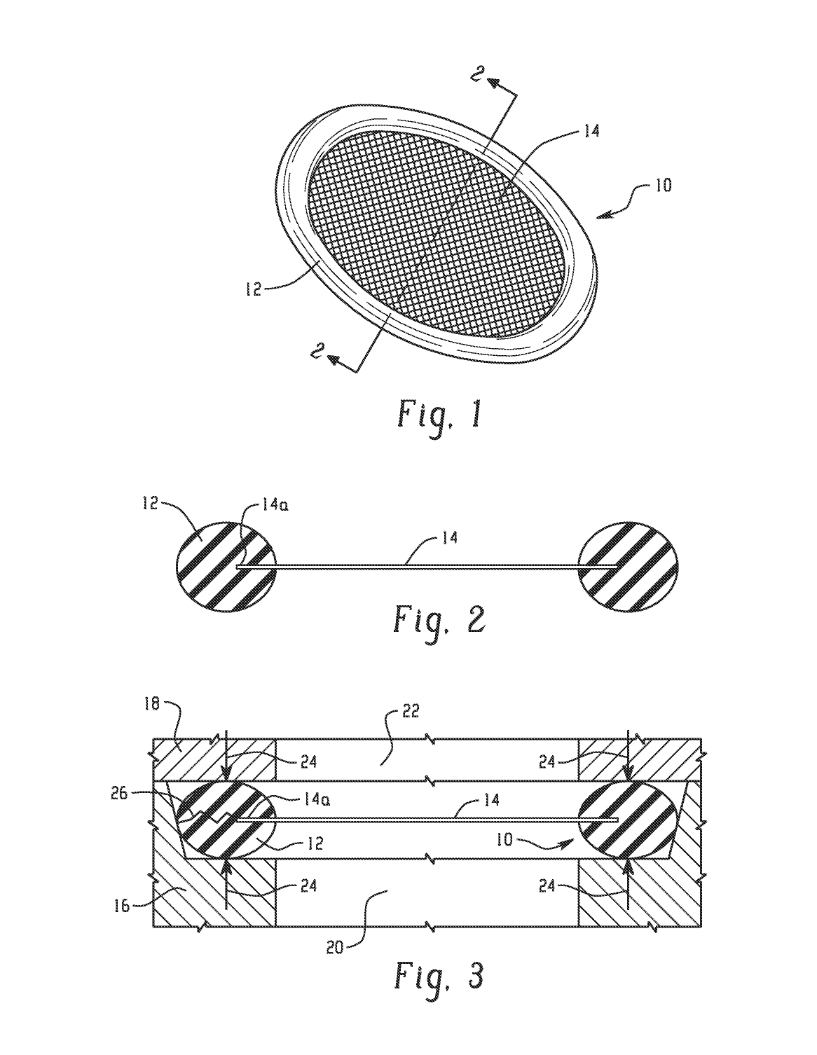

### DETAILED DESCRIPTION

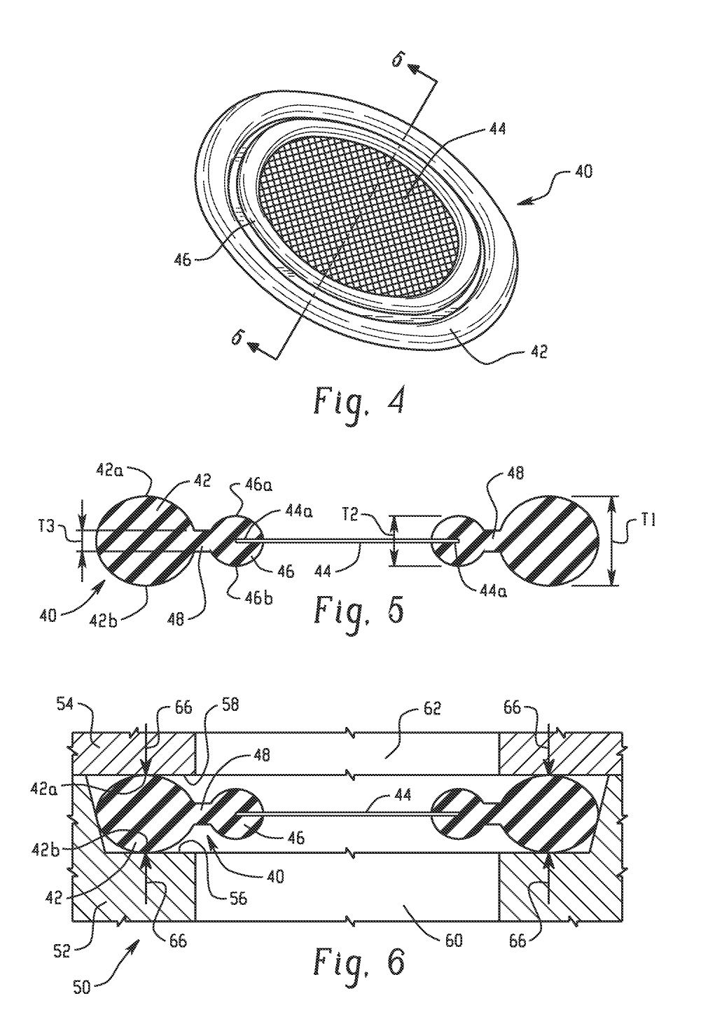

Referring now to the drawings wherein the showings are for purposes of illustrating one or more exemplary embodiments and not for purposes of limiting same, FIGS. 4-6 illustrate an O-ring filter seal 40 and filter assembly (FIG. 6) according to one or more exemplary embodiments. As shown, the illustrated O-ring filter seal 40 includes an annular sealing portion 42, a circular mesh filter 44 and an inner portion 46 formed integrally with the annular sealing portion 42. The inner portion 46 is disposed radially inwardly relative to the annular sealing portion 42. The inner portion 46 can be overmolded onto a peripheral edge 44a of the circular mesh filter 44.

With particular reference to FIG. 5, the annular sealing portion 42 has a first axial thickness T1 and the inner portion 46 has a second axial thickness T2 that is less than the first axial thickness T1. In the illustrated embodiment, the annular sealing portion 42 has an O-ring profile, though this is not required and other profile shapes are contemplated (e.g., oval, square, etc.). Likewise, the inner portion 46 can have an O-ring profile, though this too is not required and other profile shapes are contemplated (e.g., oval, square, etc.). The inner portion 46 is connected to the sealing portion 42 and radially spaced apart therefrom by a bridge portion 48. The bridge portion 48 can be narrowed relative to the sealing portion 42 and/or the inner portion 46 to reduce the amount of stress load passed to the inner portion 46 from the sealing portion 42. In particular, the bridge portion 48 can have a third axial thickness T3 that is less than the first axial thickness T1 and less than the second axial thickness T2.

In the illustrated embodiment, an upper side 42a of the sealing portion 42 is elevated relative to an upper side 46a of the inner portion 46. That is, the upper side 46a of the inner portion 46 is axially spaced apart from the upper side 42a of the sealing portion 42 such that a body having a flat planar surface contacting the upper side 42a would not contact the upper side 46a. Similarly, a lower side 46b of the inner portion 46 is elevated relative to a lower side 42b of the sealing portion 42. That is, the lower side 46b of the inner portion 46 is axially spaced apart from the lower side 42b of the sealing portion 42 such that a body having a planar surface contacting the lower side 42b would not contact the lower side 46b.

In one embodiment, the sealing and inner portions 42, 46 are integrally formed of rubber, though they could be formed of other materials. The mesh filter 44 can be a wire mesh filter that is overmolded during molding of the sealing and inner portions 42, 46 when forming the O-ring filter seal 40. In one example, the wire mesh filter 44 is formed of a metal, though other filtering materials could be used.

With reference now to FIG. 6, a filter assembly 50 is illustrated wherein the O-ring filter seal 40 is interposed between first and second bodies 52, 54 for sealing therebetween and allowing fluid communication without leakage between the bodies 52, 54. As shown, the first body 52 includes a first bearing surface 56 against which the seal 40, and particularly the lower side 42b of the sealing portion 42 is engaged or in contact. The second body 54 includes a second bearing surface 58 which is spaced apart and opposite from the first bearing surface 56. The seal 40, and particularly the upper side 42a of the sealing portion 42, is engaged or in contact with the second bearing surface 58.

The O-ring seal 40 is interposed between the first and second bodies 52, 54, and more particularly is interposed between the first and second bearing surfaces 56, 58 of the bodies 52, 54. The annular sealing portion 42 of the O-ring seal 40 is in contact with the first and second bearing surfaces 56, 58. The inner portion 46 that is integrally formed with the sealing portion 42 and disposed radially inwardly relative to the sealing portion 42 is arranged so as to be spaced apart from at least one of the first and second bearing surfaces 56, 58 to reduce a stress load applied by the bodies 52, 54, and particularly by the first and/or second bearing surfaces 56, 58, onto the portion 46 of the O-ring seal 40 holding the mesh filter 44.

More specifically, in the illustrated embodiment, the inner portion 46 is axially spaced apart from the first bearing surface 56 and is axially spaced apart from the second bearing surface 58. The inner portion 46 is also radially spaced apart from at least one of the first and second bearing surfaces 56, 58. In particular, fluid passages 60, 62 are respectively defined through the bodies 52, 54 and the bearing surfaces 56, 58 are annularly disposed around the respective fluid passages 60, 62. Accordingly, the bearing surfaces 56, 58 in the illustrated embodiment radially terminate outside and away from the inner portion 46 of the seal 40 such that the inner portion 46 is radially spaced apart from the first and second bearing surfaces 56, 58. In particular, and as shown with respect to the illustrated embodiment, the bridge portion 48 radially spaces the inner portion 46 from the sealing portion 42 and the first and second bearing surfaces 56, 58. This also results in the peripheral edge of 44a of the mesh filter 44 being radially spaced apart from the annular sealing portion 42 and also from the bearing surfaces 56, 58.

In the illustrated embodiment, the inner portion 46 is approximately centered relative to the sealing portion 42 such that the sides 46a, 46b of the inner portion 46 are axially spaced apart equal distances, respectively, from the sides 42a, 42b of the sealing portion 42, though this is not required. For example, and in view of the radial spacing of the inner portion 46 from the sealing portion 42, one or both sides 46a, 46b of the inner portion 46 need not be spaced apart from the sides 42a, 42b of the sealing portion 42. Also, if desired, the inner portion 46 can be sized so as to be the same or even larger than the sealing portion 42, though sizing of the bridge portion 48 may need to change accordingly.

Advantageously, by spacing the inner portion 46, which is overmolded onto the outer peripheral edge 44a of the mesh filter 44, from the sealing portion 42, leak toughness of the seal 40 is improved, particularly as compared to existing overmold mesh O-ring filters (e.g., O-ring filter 10). In particular, such an arrangement spaces apart to the inner portion 46 from the sealing portion 42. The sealing portion 42 receives the compressive stress loading as indicated by arrows 66 and such loading 66 is spaced apart from the inner portion 46. This reduces the likelihood of stress cracks growing at the location of the overmold (i.e., at the inner portion 46 which is overmolded onto the mesh filter 44) and resulting in leakage between bodies in which the O-ring seal 40 is deployed (e.g., bodies 52, 54).

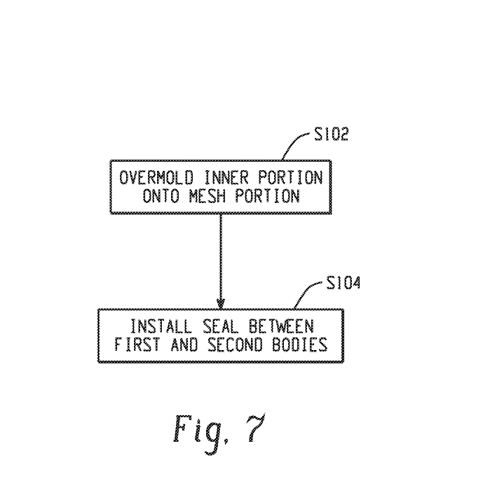

With reference now to FIG. 7, a method for assembling an O-ring filter assembly will be described. In particular, the method of FIG. 7 will be described in association with the O-ring filter assembly 50 of FIG. 6 employing the O-ring filter seal 40, though it is to be appreciated by those skilled in the art that the method could be employed with other O-ring filter assemblies and/or other O-ring filter seals. In S102, an inner portion of an O-ring filter seal is overmolded onto a mesh filter. For example, the inner portion 46 of the O-ring filter seal 40 is overmolded onto the mesh filter 44. As already described herein, the inner portion 46 can be integrally formed with the annular sealing portion 42, which is disposed radially outside the inner portion 46. As also already described, the annular sealing portion 42 has the first thickness T1 and the inner portion 46 has the second thickness T2, the second thickness T2 being less than the first thickness T1.

Next, in S104, the O-ring filter seal 40 is installed between a first body and a second body. The first and second bodies could be, for example, the first and second bodies 52, 54 of FIG. 6 having the first and second bearing surfaces 56, 58, respectively. As already described, the bearing surfaces 56, 58 are engaged or in contact with the sealing portion 42 and apply a stress load thereto that is spaced apart form the inner portion 46 that is overmolded on the filter mesh 44. That is, the location(s) on the O-ring filter seal 40 at which the stress loads is applied by the bearing surfaces 56, 58 are spaced apart from the inner portion 46.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. An O-ring filter seal, comprising:
an annular sealing portion having a first thickness;
a circular mesh filter; and
an inner portion formed integrally with the annular sealing portion and disposed radially inwardly relative to the annular sealing portion, the inner portion overmolded onto a peripheral edge of the circular mesh filter and having a second thickness that is less than the first thickness.

2. The O-ring filter seal of claim 1 wherein the annular sealing portion has an O-ring profile.

3. The O-ring filter seal of claim 1 wherein the inner portion has an O-ring profile.

4. The O-ring filter seal of claim 1 wherein the inner portion is connected to the sealing portion and radially spaced apart therefrom by a bridge portion, the bridge portion having a third thickness that is less than the second thickness.

5. The O-ring filter seal of claim 1 wherein an upper side of the sealing portion is elevated relative to an upper side of the inner portion.

6. The O-ring filter seal of claim 5 wherein a lower side of the inner portion is elevated relative to a lower side of the sealing portion.

7. The O-ring filter seal of claim 1 wherein the sealing and inner portions are formed of rubber.

8. The O-ring filter seal of claim 1 wherein the mesh filter is a ferrous wire

9. A filter assembly, comprising:
a first bearing surface;
a second bearing surface spaced apart and opposite from the first bearing surface; and
an O-ring seal interposed between the first and second bearing surfaces, the O-ring seal having an annular sealing portion in contact with the first and second bearing surfaces and an inner portion formed integrally with the annular sealing portion and disposed radially inwardly relative to the annular sealing portion, the inner portion overmolded onto a mesh filter and arranged so as to be spaced apart from at least one of the first and second bearing surfaces to reduce a stress load from the first and second bearing surfaces to the inner portion of the O-ring seal that holds the mesh filter.

10. The filter assembly of claim 9 wherein the inner portion is axially spaced apart from the first bearing surface.

11. The filter assembly of claim 10 wherein the inner portion is axially spaced apart from the second bearing surface.

12. The filter assembly of claim 11 wherein the inner portion is radially spaced apart from the first and second bearing surfaces.

13. The filter assembly of claim 9 wherein the inner portion is radially spaced apart from at least one of the first and second bearing surfaces.

14. The filter assembly of claim 13 wherein the inner portion is connected to the annular sealing portion by a bridge portion having an axial thickness that is less than that of the sealing portion and the inner portion.

15. The filter assembly of claim 14 wherein the inner portion has an axial thickness that is less than that of the annular sealing portion.

16. The filter assembly of claim 9 wherein the annular sealing portion has an O-ring shaped profile.

17. The filter assembly of claim 9 wherein a peripheral edge of the mesh filter is radially spaced apart from the annular sealing portion.

18. A method for assembling an O-ring filter assembly, comprising:
overmolding an inner portion of an O-ring filter seal onto a mesh filter, the inner portion integrally formed with an annular sealing portion disposed radially outside the inner portion, the annular sealing portion having a first thickness and the inner portion having a second thickness, the second thickness less than the first thickness;
installing the O-ring filter seal between a first body and a second body, the first body having a first bearing surface and the second body having a second bearing surface, the first and second bearing surfaces engaged with the sealing portion and applying a stress load thereto that is spaced apart from the inner portion overmolded on the filter mesh.

19. The method of claim 18 wherein the inner portion is connected to the sealing portion by a bridge portion that is narrowed relative to the inner portion and the sealing portion to reduce the amount of the stress load passed to the inner portion.

20. The method of claim 18 further including forming the O-ring seal of rubber.
